(19) United States
(12) Patent Application Publication
(10) Pub. No.: US 2024/0161952 A1
(43) Pub. Date: May 16, 2024

(54) R-T-B SINTERED MAGNET

(71) Applicant: Shin-Etsu Chemical Co., Ltd.,, Tokyo (JP)

(72) Inventors: Akihiro Yoshinari, Echizen-shi (JP); Hiroki Iida, Echizen-shi (JP); Koichi Hirota, Echizen-shi (JP)

(73) Assignee: Shin-Etsu Chemical Co., Ltd.,, Tokyo (JP)

(21) Appl. No.: 18/494,864

(22) Filed: Oct. 26, 2023

(30) Foreign Application Priority Data
Nov. 16, 2022 (JP) 2022-183378

(51) Int. Cl. H01F 1/057

(52) U.S. Cl. CPC H01F 1/0577

(57) ABSTRACT

A R-T-B sintered magnet comprising a main phase of R₂Fe₁₄B and a grain boundary phase exhibits a high Br and elevated-temperature stability. The magnet is composed of 12.5-17.0 atom % of R which is typically Nd and Pr, 4.5-5.5 atom % of B, at least 70 atom % of T which is Fe and Co, 0.1-3.0 atom % of M₁ which is typically Al, Cu or Ga, 0.01-0.5 atom % of M₂ which is typically Sn, 0.05-1.0 atom % of M₃ which is typically Zr, and up to 0.8 atom % of O, and the balance of C, N and incidental impurities. The grain boundary phase contains a R-T-(M₁, M₂) phase and a R-M₂-C phase.

### CROSS-REFERENCE TO RELATED APPLICATIONS

This non-provisional application claims priority under 35 U.S.C. § 119(a) on Patent Application No. 2022-183378 filed in Japan on Nov. 16, 2022, the entire contents of which are hereby incorporated by reference.

### TECHNICAL FIELD

This invention relates to a R-T-B sintered magnet having a high remanence and coercivity.

### BACKGROUND ART

R-T-B sintered magnets, which are sometimes referred to as Nd magnets, constitute a class of functional material which is essential for energy saving and greater functional performance. Their application range and production quantity are annually expanding. They are used, for example, in drive motors in hybrid cars and electric vehicles, motors in electric power steering systems, and motors in air conditioner compressors. R-T-B sintered magnets have a high coercivity (HcJ) which is a great advantage in these applications in that the magnets withstand service in an elevated temperature environment. It is desired to further improve the HcJ of such magnets in order that motors operate in a severer environment.

One prior art approach for enhancing the HcJ of Nd magnets is to substitute heavy rare earth elements like Dy and Tb for part of R to improve the magnetocrystalline anisotropy of R₂T₁₄B phase. On the other hand, in consideration of a supply risk of rare elements like Dy and Tb from the resource aspect, active efforts are made to enhance HcJ without using heavy rare earth elements. There are proposed several techniques including size reduction of main phase crystal grains and structural control of grain boundary phase.

For example, Patent Document 1 discloses a method of preparing a permanent magnet having R₆T₁₃M phase containing Sn as M. One advantage of the permanent magnet prepared by this method is thermal stability of coercivity.

Patent Document 2 discloses a rare earth magnet containing Ga and Sn in a specific ratio. The addition of Sn is effective for restraining creation of R-T-Ga phase in intergranular grain boundary and for promoting formation of R—Ga—Cu phase, which leads to an increase in HcJ.

Regarding a rare earth magnet of a specific compositional range containing main phase grains and a grain boundary phase, Patent Document 3 proposes means for restraining demagnetization at elevated temperature of the magnet by forming a structure containing a first grain boundary phase consisting of 20 to 40 atom % of R, 60 to 75 atom % of T, and 1 to 10 atom % of M and a second grain boundary phase consisting of 50 to 70 atom % of R, 10 to 30 atom % of T, and 1 to 20 atom % of M in a specific ratio wherein R is a rare earth element, T is at least one iron family element essentially containing Fe, and M is at least one element selected from Al, Ge, Si, Sn, and Ga.

Further, Patent Document 4 describes a magnet comprising phase A and phase B of different compositions, the phase A containing a R—Fe(Co)-M₁ phase consisting essentially of 25 to 35 atom % of R which is at least two elements selected from rare earth elements inclusive of Y, essentially containing Nd and Pr, 2 to 8 atom % of M₁ which is at least two elements selected from Si, Al, Mn, Ni, Cu, Zn, Ga, Ge, Pd, Ag, Cd, In, Sn, Sb, Pt, Au, Hg, Pb, and Bi, up to 8 atom % of Co, and the balance of Fe, the R—Fe(Co)-M₁ phase being a crystalline phase in which crystallites with a size of at least 10 nm are formed at grain boundary triple junction, the phase B being an amorphous phase and/or microcrystalline phase in which crystallites with a size of less than 10 nm are formed at intergranular grain boundary or intergranular grain boundary and grain boundary triple junction. In this sintered magnet, Si, Ge, In, Sn, or Pb is added as M₁ to form two or more R—Fe(Co)-M₁ phases having different peritectic temperatures. This magnet develops a high coercivity at elevated temperature though it does not contain Dy and Tb.

### CITATION LIST

Patent Document 1: JP-A H07-130522
Patent Document 2: JP-A 2018-125445
Patent Document 3: JP-A 2015-119132
Patent Document 4: JP-A 2017-228771

### SUMMARY OF THE INVENTION

It is noted that the term RT designates room temperature (or normal temperature), ET designates elevated temperature (or high temperature), Br designates remanence (or residual magnetic flux density), and HcJ designates coercivity. In this connection, coercivity at room temperature is designated RT coercivity, and coercivity at elevated temperature is designated ET coercivity.

It is demonstrated in examples of Patent Document 1 that the addition of Sn is effective for elevating a temperature coefficient of coercivity of the rare earth magnet, that is, enhancing the ET stability of the rare earth magnet. The addition of Sn, however, causes a drop of RT coercivity. The ET stability-improving effect by the addition of Sn is not utilized to a full extent.

In Patent Document 2, Sn is added for the purpose of acquiring a high Br and a high HcJ while minimizing the amount of heavy rare earth elements such as Dy. The properties of the magnet are insufficient to the current demand requiring a high HcJ in excess of 20 kOe without using Dy.

In Patent Document 3, a magnet having a low demagnetization rate at ET, that is, ET stability is obtained by controlling the first and second grain boundary phases to the specific ratio. As long as the magnetic properties demonstrated therein are concerned, it seems that the cooling step after secondary aging treatment must be carried out at a rate of at least 100° C./min. Such a cooling rate is difficultly achievable in the mass scale production including the step of heat treating a number of magnets at the same time.

On the other hand, the magnet of Patent Document 4 is designed such that additive elements like Si and Sn are added to form a R—Fe(Co)-M₁ phase having a relatively high peritectic temperature for thereby improving a temperature coefficient of coercivity and acquiring a high ET coercivity. In particular, the R—Fe(Co)-M₁ phase containing Sn has a high peritectic temperature of 1,080° C. which is equal to or higher than the sintering temperature. The magnet shows a tendency that the precipitation amount of R—Fe(Co)-M₁ phase increases, that is, Br declines, as compared with the magnet wherein the additive element for elevating the peritectic temperature of R—Fe(Co)-M₁ phase is not added.

An object of the invention is to provide a R-T-B sintered magnet which exhibits a high Br and satisfactory ET stability by optimizing the composition thereof so as to form a specific structure.

In connection with a R-T-B sintered magnet consisting essentially of R which is at least one element selected from rare earth elements and essentially contains Nd, B, T which is Fe and Co, at least 90 atom % of T being Fe, M₁ which is at least one element selected from Al, Mn, Ni, Cu, Zn, Ga, Pd, Ag, Cd, Sb, Pt, Au, Hg, and Bi, M₂ which is at least one element selected from Si, Ge, In, Sn, and Pb, M₃ which is at least one element selected from Ti, V, Cr, Zr, Nb, Mo, Hf, Ta, and W, O, C, and N, the inventors have found that a R-T-B sintered magnet having a high Br and satisfactory ET stability is obtainable by adjusting the composition to a specific range and letting the grain boundary phase contain R-T-(M₁, M₂) and R-M₂-C phases having specific atom concentrations.

In one aspect, the invention provides a R-T-B sintered magnet comprising a main phase in the form of a R₂Fe₁₄B intermetallic compound and a grain boundary phase. The magnet has a composition consisting essentially of 12.5 to 17.0 atom % of R which is at least one element selected from rare earth elements and essentially contains Nd, 4.5 to 5.5 atom % of B, at least 70 atom % of T which is Fe and Co, at least 90 atom % of T being Fe, 0.1 to 3.0 atom % of M₁ which is at least one element selected from Al, Mn, Ni, Cu, Zn, Ga, Pd, Ag, Cd, Sb, Pt, Au, Hg, and Bi, 0.01 to 0.5 atom % of M₂ which is at least one element selected from Si, Ge, In, Sn, and Pb, 0.05 to 1.0 atom % of M₃ which is at least one element selected from Ti, V, Cr, Zr, Nb, Mo, Hf, Ta, and W, and up to 0.8 atom % of O, and the balance of C, N and incidental impurities. The grain boundary phase contains a R-T-(M₁, M₂) phase having higher R, M₁ and M₂ concentrations than the main phase, and a R-M₂-C phase having higher R and M₂ concentrations than the R-T-(M₁, M₂) phase, and a higher C concentration than the main phase.

In a preferred embodiment, the content of C is 0.1 to 1.0 atom %.

In a preferred embodiment, the grain boundary phase further contains a M₃ carbide phase, but not a R_{1.1}T₄B₄ compound phase and a M₃ boride phase.

In a preferred embodiment, the R-T-(M₁, M₂) phase in the grain boundary phase contains 25 to 35 atom % of R, 1 to 7 atom % of M₁, more than 0 to 5 atom % of M₂, and the balance containing T.

In a preferred embodiment, the formula (1) is met,

0.6<[M₂]/[M₁]<3.0 (1)

wherein [M₁] is an atom concentration of M₁ and [M₂] is an atom concentration of M₂, relative to the total of R, T, M₁ and M₂ in the R-T-(M₁, M₂) phase.

In a preferred embodiment, M₂ contains Sn, and the content of M₂ is 0.05 to 0.3 atom %.

In a preferred embodiment, M₂ contains Sn, and the grain boundary phase contains a R—Sn—C phase as the R-M₂-C phase.

In a preferred embodiment, the R-M₂-C phase is a R-(M₁)M₂-C phase further containing element M₁, the R-(M₁)M₂-C phase having a higher M₁ concentration than the M₁ concentration in the main phase grains.

In a preferred embodiment, the R-T-B sintered magnet has an average grain size D50 of 1.2 to 4.0 μm, calculated as the area average of equivalent circle diameters of main phase grains in a cross section parallel to the orientation direction of the R-T-B sintered magnet.

### Advantageous Effect of Invention

The R-T-B sintered magnet of the invention has a high Br and satisfactory ET stability.

### BRIEF DESCRIPTION OF THE DRAWINGS

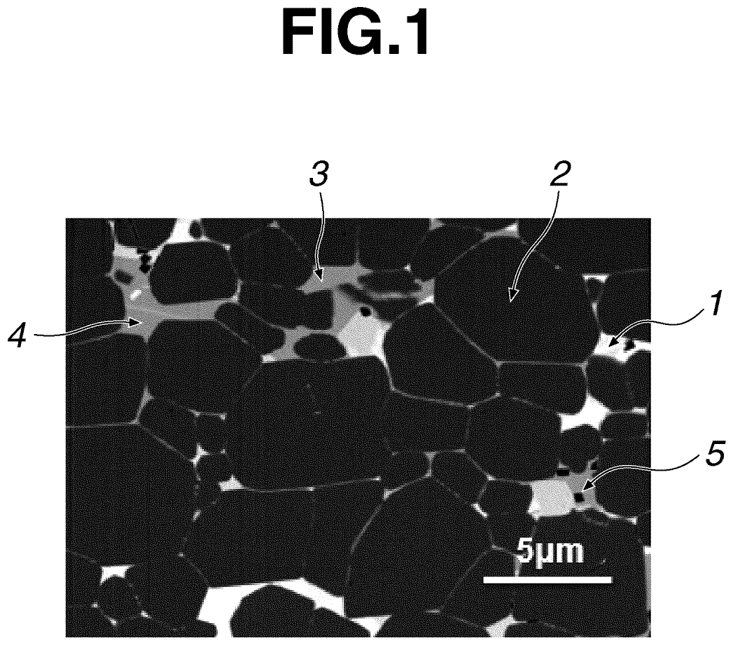

The only FIGURE, FIG. 1 is an electron micrograph (backscattered electron image) of a sintered body after low-temperature heat treatment in Example 1, as observed in a cross section parallel to the magnetization direction.

### DETAILED DESCRIPTION OF THE INVENTION

The invention provides a R-T-B sintered magnet comprising a main phase and a grain boundary phase, the magnet consisting essentially of R which is at least one element selected from rare earth elements and essentially contains Nd, B, T which is Fe and Co, at least 90 atom % of T being Fe, M₁ which is at least one element selected from Al, Mn, Ni, Cu, Zn, Ga, Pd, Ag, Cd, Sb, Pt, Au, Hg, and Bi, M₂ which is at least one element selected from Si, Ge, In, Sn, and Pb, M₃ which is at least one element selected from Ti, V, Cr, Zr, Nb, Mo, Hf, Ta, and W, O, C, and N. The grain boundary phase contains R-T-(M₁, M₂) and R-M₂-C phases having specific atom concentrations.

The element R constituting the R-T-B magnet is at least one element selected from rare earth elements and essentially contains Nd as mentioned above. Suitable rare earth elements other than Nd include Pr, La, Ce, Gd, Dy, Tb, and Ho, with Pr, Dy and Tb being preferred, and Pr being more preferred. Element R which is introduced into the magnet after sintering via grain boundary diffusion may be contained as part of element R.

The content of element R is at least 12.5 atom %, preferably at least 13.0 atom %, from the aspects of restraining crystallization of a-Fe in the source alloy during preparation and promoting densification to a full extent. Although it is difficult to eliminate a-Fe even when homogenization is conducted, the R content within the above range is effective for restraining a substantial drop of HcJ and squareness of a R-T-B sintered magnet. This also holds true when the source alloy is prepared by the strip casting method which minimizes a likelihood of crystallization of α-Fe. In addition, the R content in the range avoids that the amount of a liquid phase composed mainly of R component having the role of promoting densification in the sintering step (to be described later) is reduced to detract from sinterability so that a R—Fe—B sintered magnet is insufficiently densified. On the other hand, if the R content is too much, the proportion of R₂Fe₁₄B phase in the sintered magnet is reduced with a concomitant drop of Br. From the aspect of preventing Br drop, the R content is up to 17 atom %, preferably up to 15.5 atom %, more preferably up to 15 atom %.

The element T constituting the R-T-B magnet contains Fe and may contain Co. At least 90 atom % of T is Fe. The content of T is at least 70 atom %, preferably at least 75 atom % from the aspect of gaining a higher Br. Although the upper limit of T content is not critical, the T content is preferably up to 82 atom %, more preferably up to 80 atom % from the aspect of restraining degradation of squareness or a drop of HcJ due to precipitation of R₂T₁₇ phase.

Cobalt (Co) may substitute for part of Fe contained in element T in the R₂T₁₄B and R-T-(M₁, M₂) phases. The content of Co is preferably at least 0.1 atom %, more preferably at least 0.3 atom % of the overall magnet from the aspects of Curie temperature and corrosion resistance enhancing effect. Also, the content of Co is preferably up to 3.0 atom %, more preferably up to 2.0 atom % of the magnet from the aspect of consistent acquisition of high HcJ.

The inventive R-T-B sintered magnet contains boron (B) while carbon (C) may substitute for part of B. The content of B is at least 4.5 atom %, preferably at least 4.7 atom %, and more preferably at least 4.8 atom % and up to 5.5 atom %, preferably up to 5.3 atom %, more preferably up to 5.2 atom %. If the B content is less than 4.5 atom %, the proportion of R₂T₁₄B phase formed is low with a noticeable drop of Br, and formation of R₂T₁₇ phase aggravates squareness. If the B content exceeds 5.5 atom %, a satisfactory coercivity is not available because R_{1.1}T₄B₄ compound phase is formed and R-T-(M₁, M₂) phase is insufficiently formed. In addition, M₃ boride phase is preferentially formed to retard precipitation of M₃ carbide phase. This is undesirable because the presence of excessive carbon in the grain boundary phase induces a drop of HcJ as will be described later. In the practice of the invention, it is preferred that the grain boundary phase contain M₃ carbide phase, but not R_{1.1}T₄B₄ compound phase and M₃ boride phase, though this is not critical.

Element M₁ constituting the R-T-B magnet is at least one element selected from among Al, Mn, Ni, Cu, Zn, Ga, Pd, Ag, Cd, Sb, Pt, Au, Hg, and Bi. Addition of a specific amount of M₁ ensures consistent formation of R-T-(M₁, M₂) phase. The content of M₁ is at least 0.1 atom %, preferably at least 0.3 atom % and up to 3.0 atom %, preferably up to 1.5 atom %. If the M₁ content is less than 0.1 atom %, the R-T-(M₁, M₂) phase is formed in an insufficient amount, failing to gain a satisfactory HcJ. An M₁ content in excess of 3.0 atom % undesirably leads to a drop of Br.

Element M₂ constituting the R-T-B magnet is at least one element selected from among Si, Ge, In, Sn, and Pb. Addition of a specific amount of M₂ ensures consistent formation of R-T-(M₁, M₂) phase and R-M₂-C phase. It is preferred from the aspect of stability of R-M₂-C phase that Sn and In be contained, especially Sn be contained. The content of M₂ is at least 0.01 atom %, preferably at least 0.05 atom % and up to 0.5 atom %, preferably up to 0.3 atom %. If the M₂ content is less than 0.01 atom %, the R-T-(M₁, M₂) phase cannot be formed, failing to increase a temperature coefficient of coercivity. An M₂ content in excess of 0.5 atom % undesirably leads to a substantial drop of Br as a result of the volume proportion of the main phase being reduced.

Element M₃ constituting the R-T-B magnet is at least one element selected from among Ti, V, Cr, Zr, Nb, Mo, Hf, Ta, and W. The content of M₃ is at least 0.05 atom %, preferably at least 0.1 atom % and up to 1.0 atom %, preferably up to 0.5 atom %. A M₃ content of less than 0.05 atom % fails to exert the effect of restraining abnormal grain growth in the sintering step. A M₃ content in excess of 1.0 atom % leads to excessive formation of M₃ boride phase and M₃ carbide phase, which means that the amounts of B and C necessary to form the main phase become short. This can invite a drop of Br as a result of the proportion of the main phase being reduced and eventually, an aggravation of squareness due to formation of R₂Fe₁₇ phase. Since the ratio of elements constituting M₃ boride phase is M₃:B=1:2, the content of boron per atom of M₃ is high as compared with the ratio of elements constituting M₃ carbide phase which is M₃:C=1:1. This invites a substantial drop of the proportion of the main phase. For this reason, it is preferred that M₃ boride phase be absent in the grain boundary phase. In addition, since the M₃ carbide has a high melting point, segregates at grain boundary triple junction for thereby suppressing abnormal grain growth, and anchors C in the grain boundary phase, the HcJ enhancing effect is expectable.

The R-T-B magnet contains oxygen (O). From the aspect of gaining high HcJ at RT and high HcJ at ET, the content of O is up to 0.8 atom %, preferably up to 0.5 atom %, and more preferably up to 0.3 atom %. If the O content exceeds 0.8 atom %, the amount of R—OCN phase formed increases, which means that the amount of C which can substitute for part of the main phase is reduced, allowing R₂T₁₇ phase to precipitate to aggravate squareness.

In addition to R, T, B, M₁, M₂, M₃, and O as mentioned above, the R-T-B magnet may contain optional elements, typically carbon (C) and nitrogen (N).

The content of C in the R-T-B magnet is preferably at least 0.1 atom %, more preferably at least 0.4 atom %, even more preferably at least 0.5 atom %, and preferably up to 1.0 atom %, more preferably up to 0.8 atom %, even more preferably up to 0.7 atom %, though not critical. Carbon originates from the source material and a lubricant which is added to improve the degree of orientation of microparticles during shaping in magnetic field. When the lubricant is added in such an amount as to provide a C content of at least 0.1 atom %, a sufficient degree of orientation is achieved in the shaping step so that a high Br is obtained and R-M₂-C phase is effectively formed. On the other hand, a C content of up to 1.0 atom % is effective for suppressing a lowering of HcJ at RT due to formation of surplus C.

From the aspect of gaining satisfactory HcJ, the N content is preferably up to 1.0 atom %, more preferably up to 0.5 atom %, even more preferably up to 0.2 atom %.

The structure of the R-T-B sintered magnet contains a R₂T₁₄B intermetallic compound as the main phase. Also, the grain boundary phase contains R-T-(M₁, M₂) phase and R-M₂-C phase. In addition to these phases, the grain boundary phase may contain M₂-free R-T-M₁ phase, M₃ carbide phase, and other phases. When M₃ carbide phase segregates at grain boundary triple junction, it serves to anchor excessive carbon (or surplus C) and suppress a drop of RT coercivity. In the R-T-B sintered magnet, the grain boundary phase may further contain R-rich phase. Although it is acceptable that phases of compounds of incidental impurities which can be incidentally introduced in the preparation procedure such as R carbide, R oxide, R nitride, R halide, and R oxyhalide are included, it is recommended from the aspect of suppressing any drop of Br and HcJ that their amount is kept to the necessary minimum.

The R-T-(M₁, M₂) phase has higher R, M₁ and M₂ concentrations than the main phase. Provided that [R] is an atom concentration (atom %) of R, [M₁] is an atom concentration of M₁, and [M₂] is an atom concentration of M₂, relative to the total of R, T, M₁ and M₂ in the R-T-(M₁, M₂) phase, the R-T-(M₁, M₂) phase preferably satisfies the relationship: 25≤[R]≤35, 1≤[M₁]≤7, 0<[M₂]≤5, and 0.6<[M₂]/[M₁]<3.0, more preferably 27≤[R]≤33, 2≤[M₁]≤5, 1≤[M₂]≤4, and 0.8<[M₂]/[M₁]<2.0. Within the range, satisfactory ET coercivity is available and a drop of Br due to precipitation of R-T-(M₁, M₂) phase is suppressed. The value of [M₂]/[M₁] lowers as the B content increases. If [M₂]/[M₁] is equal to or less than 0.6, the ET coercivity may lower relative to the RT coercivity and the amount of R-T-(M₁, M₂) phase formed may increase, indicating a possible drop of Br. If [M₂]/[M₁] is equal to or more than 3.0, the amount of R-T-(M₁, M₂) phase formed may become short, failing to exert the effect of improving ET coercivity relative to RT coercivity to a full extent. It is acceptable that the M₂-free R-T-M₁ phase is present in the grain boundary phase.

From the aspect of gaining a high RT coercivity, the grain boundary phase contains a R-M₂-C phase having higher R, M₂ and C concentrations than the R-T-(M₁, M₂) phase. It is preferred from the aspect of stability of R-M₂-C phase that M₂ contain Sn or In, especially Sn. Further, the R-M₂-C phase may contain M₁ in a higher concentration than the M₁ concentration in main phase grains. Provided that [R′] is an atom concentration of R, [M₁′] is an atom concentration of M₁, [M₂′] is an atom concentration of M₂, and [C] is an atom concentration of C, relative to the total of R, M₁, M₂, and C in the R-(M₁)M₂-C phase, the R-(M₁)M₂-C phase preferably satisfies the relationship: 35≤[R′]≤55, 0≤[M₁′]≤10, 5≤[M₂′]≤25, and 25≤[C]≤45, more preferably 40≤[R′]≤50, 0≤[M₁′]≤5, 10≤[M₂′]≤20, and 30≤[C]≤40. The above range ensures consistent formation of R-(M₁)M₂-C phase which serves to anchor C in the liquid phase, exerting the HcJ improving effect.

The composition of R-T-(M₁, M₂) phase and R-M₂-C phase in the grain boundary phase can be ascertained by energy-dispersive X-ray spectroscopy (EDS) or wavelength-dispersive X-ray spectroscopy (WDS). It is generally known that on analysis of carbon by an EDS-SEM system, an analyzed value is overlapped with contamination. Therefore, on analysis of the composition of R-M₂-C phase, a clean surface must be provided by reducing or eliminating contamination. Preferably the magnet surface subject to analysis is ablated by ion milling or focused ion beam (FIB) processing, to remove the influence of oxidation or other factors from the outermost surface before analysis by the EDS system. On analysis by EDS or WDS, since it is impossible to completely eliminate the influence of C contamination, it is difficult to discuss the absolute value of C concentration. With this borne in mind, when a composition is computed from solely R, M₁ and M₂ in R-(M₁)M₂-C phase, the preferred range is 65≤[R′]≤85, 0≤[M₁′]≤10, and 15≤[M₂′]≤35, more preferably 70≤[R′]≤80, 0≤[M₁′]≤5, and 20≤[M₂′]≤30.

To identify R-T-(M₁, M₂) phase and R-M₂-C phase, their composition is preferably ascertained by obtaining electron diffraction (ED) images. The R-T-(M₁, M₂) phase is tetragonal and the R-M₂-C phase wherein M₂ is Sn or In is a cubic system of CaTiO₃ type.

For the R-T-B sintered magnet, the average grain size D50 is defined as a median value of equivalent circle diameters of main phase grains in a plane parallel to the magnetization direction of the R-T-B sintered magnet. From the aspect of obtaining satisfactory HcJ, D50 is preferably up to 4.0 μm, more preferably up to 3.5 μm. From the aspect of obtaining a satisfactory degree of orientation when the amount of lubricant added is in an appropriate range, D50 is preferably at least 1.2 μm, more preferably at least 1.8 μm.

In prior art R-T-B sintered magnets, an attempt was made to enhance the ET coercivity by adding an element capable of elevating the peritectic temperature of R₆T₁₃M phase such as Sn or Si. There arises the problem that R₆T₁₃M phase is positively formed as found immediately after sintering and quenching, to invite an outstanding drop of Br. Particularly in the magnet of Patent Document 4, Br is reduced 200 G by the addition of Sn. In contrast, the R-T-B sintered magnet of the invention wherein R-M₂-C phase is formed in a predetermined oxygen concentration and a predetermined range of element M₂ added makes it possible to suppress the drop of Br by the addition of element M₂ and to meet both high RT coercivity and ET stability. Although the reason is not well understood, the following mechanism is presumed.

First, for the effect of improving coercivity by controlling the oxygen concentration in the magnet to the range of 0.1 to 0.8 atom % which is lower than in the prior art, it is believed that coercivity increases when the amount of R in the liquid phase is increased by reducing the content of oxygen to form R oxide phase and R—OCN phase from that in the prior art. On the other hand, it is known that excessive C (or surplus C) present in the grain boundary phase as a result of reducing the content of oxygen causes a drop of RT coercivity. When R-M₂-C phase and M₃ carbide phase are formed in the sintered magnet by adding elements M₂ and M₃, formation of surplus C is restrained. On the other hand, R-T-(M₁, M₂) phase has a higher decomposition temperature than R-T-M₁ phase, and forms at grain boundary triple junction at relatively high temperature in the cooling step after sintering. Its interface with the main phase has a rounded profile, which restrains generation of reverse magnetic domains. Additionally, the local demagnetizing field in proximity to grain boundary triple junction is reduced, which is effective for restraining a drop of ET coercivity. It was difficult in the prior art to control the precipitation amount of R-T-(M₁, M₂) phase because its peritectic temperature is high. This raises a problem that an outstanding drop of Br as compared with cases free of element M₂. According to the invention, the volume fraction of R-T-(M₁, M₂) phase is reduced by adequately forming R-M₂-C phase, and the coercivity reducing influence of C is minimized. As a result, the drop of Br by the addition of element M₂ is reduced from the prior art and satisfactory ET coercivity is available.

Next, it is described how to prepare the R-T-B sintered magnet. The method for preparing the R-T-B sintered magnet involves steps which are basically the same as in the standard powder metallurgy method and not particularly limited. Generally, the method involves the steps of melting raw materials to form a source alloy of predetermined composition, pulverizing the source alloy into an alloy fine powder, compression shaping (or compacting) the alloy fine powder under a magnetic field into a compact, and heat treating the compact into a sintered body.

In the melting step, metals or alloys as raw materials are weighed so as to give the predetermined composition. After weighing, the raw materials are melted by heating, for example, high-frequency induction heating. The melt is cooled to form a starting alloy having the predetermined composition. For casting of the starting alloy, the melt casting technique of casting in a flat mold or book mold or the strip casting technique is generally employed. Also applicable herein is a so-called two-alloy technique involving separately furnishing an alloy approximate to the R₂T₁₄B compound composition that is the main phase of R-T-B alloy and an R-rich alloy serving as liquid phase aid at the sintering temperature, crushing, then weighing and mixing them. Since the alloy approximate to the main phase composition tends to allow a-Fe phase to crystallize depending on the cooling rate during casting and the alloy composition, the alloy is preferably subjected to homogenizing treatment in vacuum or Ar atmosphere at 700 to 1,200° C. for at least 1 hour, if desired, for the purpose of homogenizing the structure to eliminate the a-Fe phase. When the alloy approximate to the main phase composition is prepared by the strip casting technique, the homogenizing treatment may be omitted. To the R-rich alloy serving as liquid phase aid, not only the casting technique mentioned above, but also the so-called melt quenching technique are applicable.

The pulverizing step is, for example, a multi-stage step including coarse pulverizing and fine pulverizing steps. In the coarse pulverizing step, any suitable technique such as grinding on a jaw crusher, Brown mill or pin mill, or hydrogen decrepitation may be used. To the alloy which is prepared by the strip casting technique, the hydrogen decrepitation step is typically applied, obtaining a coarse powder which has been coarsely pulverized to a size of 0.05 to 3 mm, especially 0.05 to 1.5 mm. In the fine pulverizing step, the coarse powder is pulverized on a jet mill, for example, into a fine powder preferably having an average particle size of 0.5 to 5 μm, more preferably 1 to 3.5 μm. In either one or both of the coarse pulverizing and fine pulverizing steps, a lubricant is preferably added in an amount of 0.08 to 0.30% by weight, more preferably 0.1 to 0.2% by weight for the purpose of enhancing the degree of orientation.

Examples of the lubricant used herein include fatty acids (typically stearic acid), alcohols, esters, and metal soaps, but are not limited thereto. When it is desired to adjust the C content, part of the lubricant may be replaced by carbon black and hydrocarbons (e.g., paraffins and polyvinyl alcohol). Such carbon black and hydrocarbons other than the lubricant may be added as the carbon source as long as the amount of the lubricant added is beyond the lower limit of the defined range. Alternatively, carbon black or the like may be added in the melting step. When it is desired to adjust the O content to the specific range, the coarse pulverizing and fine pulverizing steps are preferably performed in a gas atmosphere, typically nitrogen or argon gas. Also, the oxygen concentration in the gas atmosphere may be adjusted by introducing oxygen thereto.

In the shaping step, the alloy fine powder is compression shaped into a compact on a compression shaping machine while applying a magnetic field of 400 to 1,600 kA/m thereto for orienting or aligning alloy particles in the direction of axis of easy magnetization. The compact preferably has a density of 2.8 to 4.2 g/cm³. It is preferred from the aspect of establishing a compact strength for easy handling that the compact have a density of at least 2.8 g/cm³. It is also preferred from the aspects of establishing a sufficient compact strength and achieving sufficient particle orientation during compression to gain appropriate Br that the compact have a density of up to 4.2 g/cm³. The shaping step is preferably performed in an inert gas atmosphere such as nitrogen or Ar gas to prevent the alloy powder from oxidation.

In the subsequent step, the compact resulting from the shaping step is sintered in high vacuum or a non-oxidative atmosphere such as Ar gas. Typically, the compact is sintered by holding the compact at a temperature in the range of 950° C. to 1,200° C. for 0.5 to 15 hours. After the sintering, the sintered body is cooled preferably to or below 400° C., more preferably to or below 300° C., even more preferably to or below 200° C. The cooling rate is preferably at least 5° C./min, more preferably at least 15° C./min and preferably up to 100° C./min, more preferably up to 50° C./min until the upper limit of the temperature range is reached, though not limited thereto.

After the sintering, the sintered body may be further heat treated. This heat treatment is preferably heat treatment in two stages including high-temperature heat treatment and low-temperature heat treatment, specifically, high-temperature heat treatment including heating the sintered body, which has been cooled to or below 400° C., at a temperature of preferably at least 700° C., more preferably at least 800° C. and preferably up to 1,100° C., more preferably up to 1,050° C. and cooling again to or below 400° C. and low-temperature heat treatment including heating at a temperature of 400 to 600° C. and cooling to or below 300° C., more preferably to or below 200° C. The heat treatment atmosphere is preferably vacuum or an inert gas atmosphere such as Ar gas.

In the high-temperature heat treatment, the heating rate is preferably at least 1° C./min, more preferably at least 2° C./min and preferably up to 20° C./min, more preferably up to 10° C./min, though not limited thereto. The holding time after heating is preferably at least 1 hour and up to 10 hours, more preferably up to 5 hours. After heating, the sintered body is cooled preferably to or below 400° C., more preferably to or below 300° C., even more preferably to or below 200° C. The cooling rate is preferably at least 1° C./min, more preferably at least 5° C./min and preferably up to 100° C./min, more preferably up to 50° C./min until the upper limit of the temperature range is reached, though not limited thereto.

In the low-temperature heat treatment following the high-temperature heat treatment, the cooled sintered body is heated at a temperature of preferably at least 400° C., more preferably at least 430° C. and preferably up to 600° C., more preferably up to 550° C. The heating rate is preferably at least 1° C./min, more preferably at least 2° C./min and preferably up to 20° C./min, more preferably up to 10° C./min, though not limited thereto. The holding time after heating is preferably at least 0.5 hour, more preferably at least 1 hour and up to 50 hours, more preferably up to 20 hours. The cooling rate is preferably at least 1° C./min, more preferably at least 5° C./min and preferably up to 100° C./min, more preferably up to 80° C./min, even more preferably up to 50° C./min until the upper limit of the temperature range is reached, though not limited thereto. After the heat treatment, the sintered body is typically cooled to normal temperature.

The conditions of the high-temperature heat treatment and low-temperature heat treatment may be adjusted within the above ranges, depending on variations during the preparation method excluding the high-temperature heat treatment and low-temperature heat treatment, for example, the type of element M₁, contents of elements including element M₃, the concentration of impurities, especially impurities originating from the surrounding gas during the preparation method, and sintering conditions.

### EXAMPLES

Examples of the invention are given below by way of illustration and not by way of limitation.

### Examples 1 and 2 and Comparative Examples 1 and 2

A ribbon form alloy was prepared by the strip casting technique, specifically by using a high-frequency induction furnace, melting metal and alloy ingredients in Ar gas atmosphere therein so as to meet the composition shown in Table 1, and casting the alloy melt on a water-cooled cupper chill roll. The ribbon form alloy was coarsely pulverized by hydrogen decrepitation. To the coarse powder, 0.15% by weight of stearic acid as lubricant was added and mixed. Using a jet mill, the coarse powder/lubricant mixture was finely pulverized in a nitrogen stream into a fine powder having an average particle size of 3.0 μm. The O content of the powder was adjusted by setting the jet mill system to an oxygen concentration of up to 10 ppm in Example 1 and Comparative Example 2, 50 ppm in Example 2, and 100 ppm in Comparative Example 1.

A mold of a shaping machine equipped with an electromagnet was filled with the fine powder in nitrogen atmosphere. While being oriented under a magnetic field of 15 kOe (1.19 MA/m), the powder was compression shaped in a direction perpendicular to the magnetic field. The resulting compact was sintered in vacuum at 1,080° C. for 5 hours, cooled below 200° C. at a rate of 20° C./min, subjected to high-temperature heat treatment at 900° C. for 2 hours, cooled again below 200° C. at a rate of 20° C./min, subjected to low-temperature heat treatment at 450° C. for 3 hours, and cooled below 200° C. at a rate of 20° C./min, yielding a sintered body. The composition of the sintered magnet is shown in Table 1. The magnet was analyzed for metal elements by the ICP spectroscopy, for oxygen concentration by the inert gas fusion infrared absorption method, for nitrogen concentration by the inert gas fusion thermal conductivity method, and for carbon concentration by the infrared absorptiometry after combustion.

TABLE 1

| Atom % | Nd | Pr | Fe | Co | B | Al | Cu | Zr | Ga | Sn | O | C | N |
|---|---|---|---|---|---|---|---|---|---|---|---|---|---|
| Example 1 | 11.0 | 3.3 | 76.9 | 0.5 | 5.2 | 0.5 | 0.5 | 0.3 | 0.5 | 0.1 | 0.3 | 0.6 | 0.3 |
| Example 2 | 11.0 | 3.3 | 76.8 | 0.5 | 5.2 | 0.5 | 0.5 | 0.3 | 0.5 | 0.1 | 0.5 | 0.6 | 0.2 |
| Comparative | 10.9 | 3.3 | 76.5 | 0.5 | 5.2 | 0.5 | 0.5 | 0.3 | 0.5 | 0.1 | 1.0 | 0.6 | 0.1 |
| Example 1 | | | | | | | | | | | | | |
| Comparative | 11.1 | 3.1 | 77.0 | 0.5 | 5.2 | 0.5 | 0.5 | 0.3 | 0.5 | 0.0 | 0.3 | 0.6 | 0.4 |
| Example 2 | | | | | | | | | | | | | |

A parallelopiped block (sintered magnet) of 18 mm by 15 mm by 12 mm was cut out from a central portion of the sintered body. Magnetic properties of the sintered magnet were measured by a B—H tracer (by Toei Industry Co., Ltd.). The average crystal grain size D50 (μm) was measured by polishing a cross section of the sintered magnet parallel to its magnetization direction until mirror finish, immersing the magnet in an etchant which was a 4:4:1:1 mixture of glycerin, ethylene glycol, nitric acid and hydrochloric acid to selectively etch the grain boundary phase in the cross section, observing the etched cross section under a laser microscope to take 25 cross-sectional images of 85×85 μm area, performing an image analysis on the images to determine the cross-sectional area of individual grains, computing the diameter of equivalent circles, and computing an area average of grain diameters.

Table 2 tabulates the measured values of Br and HcJ at room temperature (˜23° C.), HcJ at 140° C., and a ratio of HcJ at 140° C. to HcJ at 23° C. (i.e., HcJ(140° C.)/HcJ(23° C.)). After a surface layer of the cross section of the sintered body was ablated by a FIB system to remove the influence of oxidation or other factors on the outermost surface, analysis was performed by an EDS-SEM system to detect R-T-(M₁, M₂) phase, to determine the ratio of M₂ concentration to M₁ concentration in the R-T-(M₁, M₂) phase, i.e., [M₂]/[M₁], and to detect R-M₂-C phase, M₃ boride phase, and M₃ carbide phase. The results are shown in Table 3.

TABLE 2

| | D50 | Br | HcJ (23° | HcJ (140° | HcJ (140° C.)/ |
|---|---|---|---|---|---|
| | (μm) | (T) | C.) (kA/m) | C.) (kA/m) | HcJ (23° C.) |
| Example 1 | 3.5 | 1.362 | 1,646 | 600 | 0.365 |
| Example 2 | 3.4 | 1.343 | 1,565 | 565 | 0.361 |
| Comparative | 3.4 | 1.349 | 1,480 | 518 | 0.350 |
| Example 1 | | | | | |
| Comparative | 3.4 | 1.370 | 1,611 | 546 | 0.339 |
| Example 2 | | | | | |

TABLE 3

| | R-T- | | | M₃ | M₃ |
|---|---|---|---|---|---|
| | (M₁, M₂) | [M₂]/ | R-M₂-C | boride | carbide |
| | phase | [M₁] | phase | phase | phase |
| Example 1 | detected | 1.0 | detected | not detected | detected |
| Example 2 | detected | 0.9 | detected | not detected | detected |
| Comparative | detected | 1.0 | not detected | detected | detected |
| Example 1 | | | | | |
| Comparative | not detected | — | not detected | not detected | detected |
| Example 2 | | | | | |

It is evident from Tables 1 and 2 that of magnets having different oxygen concentrations, the sintered magnets of Examples 1 and 2 prepared by the method so as to meet the requirements of the invention show a higher coercivity at 140° C. than Comparative Example 1. While the magnets of Examples 1 and 2 and Comparative Example 1 have equivalent ratios of ET coercivity to RT coercivity, the RT coercivity is higher as the oxygen concentration is lower. It is evident from Table 3 that for the magnets of Examples 1 and 2 having high RT coercivity and high ET coercivity, the R-M₂-C phase was detected in its magnet structure whereas the R-M₂-C phase was not detected in Comparative Example 1. For the M₃ compound phases, element M₃ forms only carbide in Examples 1 and 2, whereas element M₃ forms boride and carbide in Comparative Example 1. A comparison between Example 1 and Comparative Example 2 having an equal oxygen concentration and having Sn added or not reveals that Example 1 having Sn added has superior RT and ET coercivities to Comparative Example 2. Since the drop of Br caused by Sn addition is less than 100 G, the magnet within the scope of the invention is successful in suppressing the drop of Br by Sn addition.

For the sintered body after low-temperature heat treatment in Example 1, its cross section in a direction parallel to the magnetization direction was observed under electron microscope. FIG. 1 is an electron micrograph (backscattered electron image) of the sintered body. In the magnet of Example 1, the R-T-(M₁, M₂) phase depicted at 3 in FIG. 1 and the R-M₂-C phase depicted at 1 in FIG. 1 are observed. Analysis was performed by the EDS system at ten points within main phase grains depicted at 2 in FIG. 1, ten points in the R-T-(M₁, M₂) phase, and ten points in the R-M₂-C phase, for determining an average composition. The atom percent of each of the elements was computed. The results are shown in Table 4. Notably, the R-T-M₁ phase is depicted at 4, and the M₃ carbide phase is depicted at 5 in FIG. 1.

TABLE 4

| | | Compositional ratio (at %) | | | | | | | |
|---|---|---|---|---|---|---|---|---|---|
| | | R | Fe | Co | Cu | Al | Ga | Sn | C |
| Example 1 | Main phase | 11.4 | 71.7 | 0.4 | 0.3 | 0.2 | 0.2 | 0.0 | 15.8 |
| | R-T-(M₁, M₂) phase | 23.9 | 51.6 | 0.4 | 0.1 | 0.4 | 2.0 | 2.1 | 19.5 |
| | R-M₂-C phase | 44.3 | 7.4 | 0.2 | 0.3 | 0.1 | 1.2 | 11.3 | 35.2 |

### Examples 3 and 4 and Comparative Examples 3 and 4

A ribbon form alloy was prepared by the strip casting technique, specifically by using a high-frequency induction furnace, melting metal and alloy ingredients in Ar gas atmosphere therein so as to meet the composition shown in Table 5, and casting the alloy melt on a water-cooled cupper chill roll. The ribbon form alloy was coarsely pulverized by hydrogen decrepitation. To the coarse powder, stearic acid as lubricant was added and mixed in an amount of 0.15% by weight in Examples 3 and 4 and Comparative Example 3 or 0.09% by weight in Comparative Example 4. Using a jet mill, the coarse powder/lubricant mixture was finely pulverized in a nitrogen stream having an oxygen concentration of up to 10 ppm into a fine powder having an average particle size of ˜3.0 μm.

Subsequently, shaping and heat treatment were carried out by the same procedures as in Example 1. Magnetic properties and average grain size were similarly measured. The results are shown in Table 6. As in Example 1, analysis was performed to detect R-T-(M₁, M₂) phase, to determine the ratio of M₂ concentration to M₁ concentration in the R-T-(M₁, M₂) phase, i.e., [M₂]/[M₁], and to detect R-M₂-C phase, M₃ boride phase, and M₃ Carbide phase. The results are shown in Table 7.

TABLE 5

| Atom % | Nd | Pr | Fe | Co | B | Al | Cu | Zr | Ga | Sn | O | C | N |
|---|---|---|---|---|---|---|---|---|---|---|---|---|---|
| Example 3 | 11.2 | 3.1 | 77.1 | 0.5 | 5.1 | 0.5 | 0.5 | 0.2 | 0.5 | 0.1 | 0.3 | 0.6 | 0.3 |
| Example 4 | 11.2 | 3.1 | 76.9 | 0.5 | 5.2 | 0.5 | 0.5 | 0.2 | 0.5 | 0.2 | 0.3 | 0.6 | 0.3 |
| Comparative | 11.1 | 3.1 | 76.7 | 0.5 | 5.1 | 0.5 | 0.5 | 0.2 | 0.5 | 0.6 | 0.3 | 0.6 | 0.3 |
| Example 3 | | | | | | | | | | | | | |
| Comparative | 10.9 | 3.3 | 77.0 | 0.5 | 5.6 | 0.3 | 0.5 | 0.3 | 0.5 | 0.1 | 0.3 | 0.4 | 0.3 |
| Example 4 | | | | | | | | | | | | | |

TABLE 6

| | D50 | Br | HcJ (23° | HcJ (140° | HcJ (140° C.)/ |
|---|---|---|---|---|---|
| | (μm) | (T) | C.) (kA/m) | C.) (kA/m) | HcJ (23° C.) |
| Example 3 | 3.5 | 1.371 | 1,674 | 616 | 0.368 |
| Example 4 | 3.5 | 1.346 | 1,594 | 577 | 0.362 |
| Comparative | 3.6 | 1.329 | 1,482 | 521 | 0.352 |
| Example 3 | | | | | |
| Comparative | 3.5 | 1.375 | 1,515 | 485 | 0.320 |
| Example 4 | | | | | |

TABLE 7

| | R-T- | | | M₃ | M₃ |
|---|---|---|---|---|---|
| | (M₁, M₂) | [M₂]/ | R-M₂-C | boride | carbide |
| | phase | [M₁] | phase | phase | phase |
| Example 3 | detected | 0.7 | detected | not detected | detected |
| Example 4 | detected | 1.0 | detected | not detected | detected |
| Comparative | detected | 1.1 | detected | not detected | detected |
| Example 3 | | | | | |
| Comparative | not detected | — | detected | detected | not detected |
| Example 4 | | | | | |

It is evident from Tables 5 to 7 that as compared with Comparative Example 2 (Table 2) in which Sn is not added, the magnets of Examples 3 and 4 in which Sn is added in an amount within the specific range show approximately equal RT coercivity and high ET coercivity. The magnet of Comparative Example 3 in which an excess of Sn is added shows drops of Br, RT coercivity and ET coercivity as compared with Examples 3 and 4. In the magnet of Comparative Example 4 in which the amount of B added exceeds the specific range, R-M₂-C phase is detected, but R-T-(M₁, M₂) phase is not detected, and the ratio of ET coercivity to RT coercivity is low as compared with Examples 2 and 3.

Japanese Patent Application No. 2022-183378 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A R-T-B sintered magnet comprising a main phase in the form of a R₂Fe₁₄B intermetallic compound and a grain boundary phase, wherein
the magnet has a composition consisting essentially of 12.5 to 17.0 atom % of R which is at least one element selected from rare earth elements and essentially contains Nd, 4.5 to 5.5 atom % of B, at least 70 atom % of T which is Fe and Co, at least 90 atom % of T being Fe, 0.1 to 3.0 atom % of M₁ which is at least one element selected from Al, Mn, Ni, Cu, Zn, Ga, Pd, Ag, Cd, Sb, Pt, Au, Hg, and Bi, 0.01 to 0.5 atom % of M₂ which is at least one element selected from Si, Ge, In, Sn, and Pb, 0.05 to 1.0 atom % of M₃ which is at least one element selected from Ti, V, Cr, Zr, Nb, Mo, Hf, Ta, and W, and up to 0.8 atom % of O, and the balance of C, N and incidental impurities,
the grain boundary phase contains a R-T-(M₁, M₂) phase having higher R, M₁ and M₂ concentrations than the main phase, and a R-M₂-C phase having higher R and M₂ concentrations than the R-T-(M₁, M₂) phase, and a higher C concentration than the main phase.

2. The R-T-B sintered magnet of claim 1 wherein the content of C is 0.1 to 1.0 atom %.

3. The R-T-B sintered magnet of claim 1 wherein the grain boundary phase further contains a M₃ carbide phase, but not a R_{1.1}T₄B₄ compound phase and a M₃ boride phase.

4. The R-T-B sintered magnet of claim 1 wherein the R-T-(M₁, M₂) phase in the grain boundary phase contains 25 to 35 atom % of R, 1 to 7 atom % of M₁, more than 0 to 5 atom % of M₂, and the balance containing T.

5. The R-T-B sintered magnet of claim 1 wherein the formula (1) is met,
0.6<[M₂]/[M₁]<3.0 (1)
wherein [M₁] is an atom concentration of M₁ and [M₂] is an atom concentration of M₂, relative to the total of R, T, M₁ and M₂ in the R-T-(M₁, M₂) phase.

6. The R-T-B sintered magnet of claim 1 wherein M₂ contains Sn, and the content of M₂ is 0.05 to 0.3 atom %.

7. The R-T-B sintered magnet of claim 1 wherein M₂ contains Sn, and the grain boundary phase contains a R—Sn—C phase as the R-M₂-C phase.

8. The R-T-B sintered magnet of claim 1 wherein the R-M₂-C phase is a R-(M₁)M₂-C phase further containing element M₁, the R-(M₁)M₂-C phase having a higher M₁ concentration than the M₁ concentration in the main phase grains.

9. The R-T-B sintered magnet of claim 1 which has an average grain size D50 of 1.2 to 4.0 μm, calculated as the area average of equivalent circle diameters of main phase grains in a cross section parallel to the orientation direction of the R-T-B sintered magnet.
